(19) United States
(12) Patent Application Publication
(10) Pub. No.: US 2012/0249514 A1
(43) Pub. Date: Oct. 4, 2012

(54) Organic light emitting display device, data driving apparatus for organic light emitting display device, and driving method thereof

(76) Inventor: Jung-Keun Ahn, Yongin-City (KR)

(21) Appl. No.: 13/200,396

(22) Filed: Sep. 23, 2011

(30) Foreign Application Priority Data
Apr. 1, 2011 (KR) 10-2011-0030310

(51) Int. Cl. G06F 3/038; G09G 3/32

(52) U.S. Cl. 345/212; 345/82

(57) ABSTRACT

An organic light emitting display device comprises: a display unit; a power supply unit including a power source which generates a power supply voltage to drive the display unit; a data compensator that adapts a voltage drop, caused by a resistance of power lines supplying the power supply voltage from the power source to a pixel included in the display unit, to a data voltage of the pixel and generates a compensated data voltage of the pixel; and a data driver that applies the compensated data voltage to the display unit.

### CROSS-REFERENCE TO RELATED APPLICATION

This application claims priority to and the benefit of Korean Patent Application No. 10-2011-0030310 filed in the Korean Intellectual Property Office on Apr. 1, 2011, the entire contents of which are incorporated herein by reference.

### BACKGROUND

1. Field

Embodiments relate to an organic light emitting display device, a data driving apparatus for an organic light emitting display device, and a driving method thereof.

2. Description of the Related Art

Recently, various types of flat panel displays have been developed that reduce weight and volume. Weight and volume are disadvantages of cathode ray tubes. Flat panel displays may include liquid crystal displays, field emission displays, plasma display panels, and organic light emitting displays, etc.

Flat panel displays may be classified into a passive matrix type light emitting display device and an active matrix type light emitting display device in accordance with a driving scheme of the pixels. The active matrix type, which selectively lights every unit pixel, is primarily used due to resolution, contrast, and operation speed characteristics.

A flat panel display includes a display panel including a plurality of pixels arranged in a matrix format. The display panel includes a plurality of scan lines formed in a row direction and a plurality of data lines formed in a column direction. The plurality of scan lines and the plurality of data lines are arranged to cross each other. Each pixel is driven by a scan signal and a data signal supplied from its corresponding scan line and data line.

The active matrix type organic light emitting display AMOLED displays an image by causing a current to flow to an organic light emitting diode, and produce light. The organic light emitting diode is a light emitting element. The driving thin film transistor (TFT) of each pixel causes a current to flow in accordance with the gradation of image data.

The above information disclosed in the Background is only for enhancing an understanding of the technology. Therefore, it may contain information that does not form the prior art already known to a person of ordinary skill in the art in this country.

### SUMMARY

Embodiments are directed to an organic light emitting display device, a data driving apparatus for an organic light emitting display device, and a driving method thereof.

An exemplary embodiment may be directed to an organic light emitting display device comprising: a display unit; a power supply unit including a power source which generates a power supply voltage to drive the display unit; a data compensator that adapts a voltage drop, caused by a resistance of power lines supplying the power supply voltage from the power source to a pixel included in the display unit, to a data voltage of the pixel, and generates a compensated data voltage of the pixel; and a data driver that applies the compensated data voltage to the display unit.

The pixel may include: an organic light emitting diode and a driving transistor that controls an amount of current flowing to the organic light emitting diode from the power source in response to the compensated data voltage.

The driving transistor may be a p-channel field effect transistor, and the compensated data voltage may be generated by subtracting the voltage drop from the data voltage of the pixel.

The driving transistor may be an n-channel field effect transistor, and the compensated data voltage may be generated by adding the voltage drop to the data voltage of the pixel.

The data compensator may include: a voltage calculator for calculating the data voltage of the pixel from an image data signal; a current calculator for calculating a pixel current of the pixel from the image data signal; an ELVDD calculator for calculating an ELVDD voltage, obtained by subtracting the voltage drop from the power supply voltage, by using the pixel current; and a compensated data generator for calculating the compensated data voltage by using the data voltage and the ELVDD voltage.

The voltage calculator may calculate the data voltage from the image data signal based on a light emission efficiency of the organic light emitting diode included in the pixel.

The current calculator may calculate the pixel current based on a ratio of gray levels of the pixel to a total number of gray levels.

The compensated data generator may calculate the compensated data voltage by subtracting the voltage drop from the data voltage of the pixel.

The compensated data generator may calculate the compensated data voltage by adding the voltage drop to the data voltage of the pixel.

Another exemplary embodiment may be directed to a data driving apparatus for an organic light emitting display device, the data driving apparatus comprising: a voltage calculator for calculating a data voltage of each of a plurality of pixels from an image data signal; a current calculator for calculating a current of each of the plurality of pixels from the image data signal; an ELVDD calculator for calculating an ELVDD voltage of each of the plurality of pixels, obtained by subtracting a voltage drop caused by a resistance of power lines from a power supply voltage of a power source, by using the current of each of the plurality of pixels; a compensated data generator for calculating a compensated data voltage of each of the plurality of pixels by using the data voltage of each of the plurality of pixels and the ELVDD voltage of each of the plurality of pixels; and a data driver for applying the compensated data voltage to a display unit including the plurality of pixels.

The voltage calculator may calculate the data voltage from the image data signal based on a light emission efficiency of a plurality of organic light emitting diodes included in the plurality of pixels.

The current calculator may calculate the current of each of the plurality of pixels according to Ip=K×(ELVDD−Vdata_max×(Gray_DAT/Gray_max)^{Y})², where Ip represents the current of each of the plurality of pixels, K represents a process constant determined by a characteristic of a driving transistor for supplying the current of each of the plurality of pixels to the organic light emitting diode included in each of the plurality of pixels, Vdata_max represents a data voltage for conducting the driving transistor to a maximum extent, Gray_DAT represents a gray level of each of the plurality of pixels, and Gray_max represents a maximum number of representable gray levels, and γ represents a gamma value.

The compensated data generator may calculate the compensated data voltage of each of the plurality of pixels according to Vdat′=Vdat−(ELVDD−ELVDD′), where Vdat′ represents the compensated data voltage of each of the plurality of pixels, Vdat represents the data voltage of each of the plurality of pixels, ELVDD represents the power supply voltage of the power source, and ELVDD′ represents the ELVDD voltage of each of the plurality of pixels.

The compensated data generator may calculate the compensated data voltage of each of the plurality of pixels according to Vdat′=Vdat+(ELVDD−ELVDD′), where Vdat′ represents the compensated data voltage of each of the plurality of pixels, Vdat represent the data voltage of each of the plurality of pixels, ELVDD represents the power supply voltage of the power source, and ELVDD′ represents the ELVDD voltage of each of the plurality of pixels.

Still another exemplary embodiment may be directed to a driving method of a data driving apparatus for an organic light emitting display device, the method comprising: calculating a data voltage of a pixel from an image data signal; calculating a pixel current from the image data signal; calculating an ELVDD voltage of the pixel by using the pixel current; and calculating a compensated data voltage of the pixel by using the data voltage and the ELVDD voltage.

The ELVDD voltage of the pixel may be obtained by subtracting a voltage drop caused by a resistance of power lines from a power supply voltage of a power source.

The data voltage may be calculated based on a light emission efficiency of an organic light emitting diode included in the pixel.

The compensated data voltage may be calculated by subtracting the voltage drop from the data voltage.

The compensated data voltage may be calculated by adding the voltage drop to the data voltage.

### BRIEF DESCRIPTION OF THE DRAWINGS

FIG. 1 is a block diagram showing an organic light emitting display device according to an exemplary embodiment.

FIG. 2 is a circuit diagram showing a pixel example.

FIG. 3 is a block diagram showing an example of a wiring structure of power lines for describing a level of a power supply voltage actually applied to each pixel corresponding to a voltage drop across the power lines.

FIG. 4 is a block diagram showing a data driving apparatus according to an exemplary embodiment.

FIG. 5 is a flowchart showing a driving method of a data driving apparatus according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein.

In several exemplary embodiments, constituent elements having the same configuration are representatively described in a first exemplary embodiment by using the same reference numeral and only constituent elements other than the constituent elements described in the first exemplary embodiment will be described in other embodiments.

In order to clarify embodiments, elements extrinsic to the description are omitted from the details of this description, and like reference numerals refer to like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

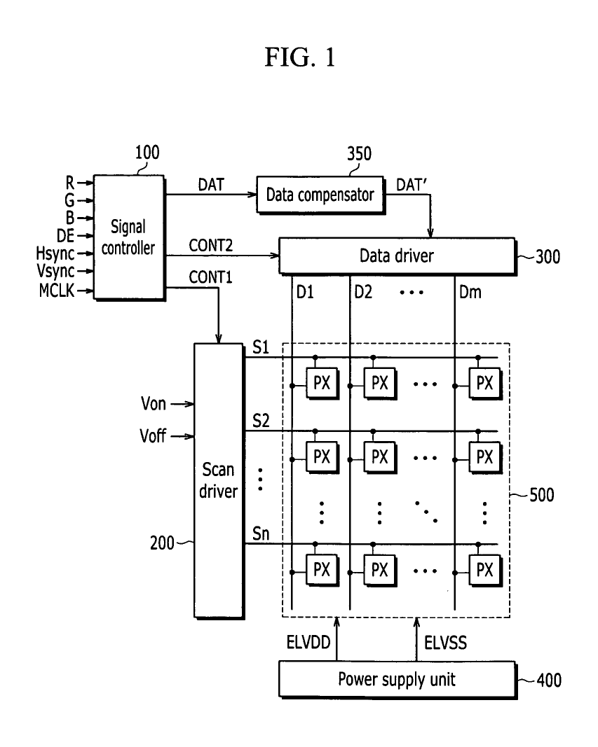

FIG. 1 is a block diagram showing an organic light emitting display device according to an exemplary embodiment.

Referring to FIG. 1, the display device comprises a signal controller 100, a scan driver 200, a data driver 300, a data compensator 350, a power supply unit 400, and a display unit 500.

The signal controller 100 receives input image signals R, G, and B and an input control signal for controlling the display thereof, which are input from an external device. The input image signals R, G, and B contain luminance information of each pixel PX. Luminance has gray levels of a given number, i.e., 1024 (=2¹⁰), 256 (=2⁸), or 64(=2⁶). Examples of the input control signal include a vertical synchronization signal Vsync, a horizontal synchronization signal Hsync, a main clock signal MCLK, and a data enable signal DE.

The signal controller 100 appropriately processes the input image signals R, G, and B according to operating conditions of the display unit 500 and the data driver 300 based on the input image signals R, G, and B, and generates a scan control signal CONT1, a data control signal CONT2, and an image data signal DAT based on the input control signal. The signal controller 100 sends the scan control signal CONT1 to the scan driver 200. The signal controller 100 sends the data control signal CONT2 to the data driver 300, and sends the image data signal DAT to the data compensator 350.

The display unit 500 comprises a plurality of pixels PX connected to a plurality of scan lines S1 to Sn, a plurality of data lines D1 to Dm. A plurality of signal line S1 to Sn and D1 to Dm and arranged substantially in a matrix format. The plurality of scan lines S1 to Sn extend substantially in a row direction and are substantially parallel with each other, and the plurality of data lines D1 to Dm extend substantially in a column direction and are substantially parallel with each other.

The power supply unit 400 supplies a first power supply voltage ELVDD and a second power supply voltage ELVSS, which drive the display unit 500. The power supply unit 400 comprises a first power source for generating the first power supply voltage ELVDD and a second power source for generating the second power supply voltage ELVSS.

The data compensator 350 adapts the ELVDD voltage, applied to each pixel due to a voltage drop across a plurality of power lines (not shown) supplying the first power supply voltage ELVDD to the plurality of pixels from the first power source, to the image data signal DAT and generates a compensated data signal DAT′. A data voltage Vdat of each pixel is derived from the image data signal DAT, and the data compensator 350 subtracts the voltage drop caused by the resistance of the power lines from the data voltage Vdat of each pixel to generate a compensated data voltage Vdat′ of each pixel. The data compensator 350 sends the compensated data signal DAT′ to the data driver 300. The compensated data signal DAT′ may comprise the compensated data voltage Vdat′ of each pixel.

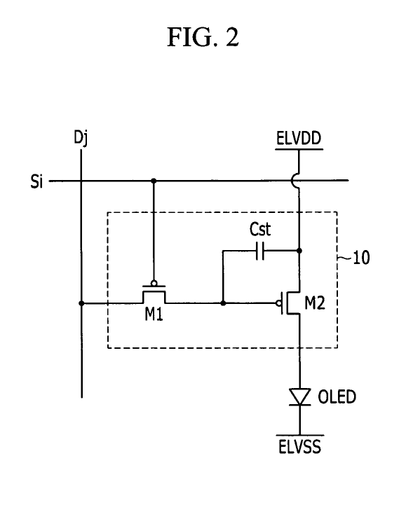

The scan driver 200 is connected to the plurality of scan lines S1 to Sn, and applies a scan signal, which is a combination of a gate on voltage Von for turning on the switching transistor (see M1 of FIG. 2) and a gate off voltage Voff for turning off the switching transistor M1, to the plurality of scan lines S1 to Sn in response to the scan control signal CONT1.

The data driver 300 is connected to the plurality of data lines D1 to Dm, and applies the compensated data voltage Vdat′ of each pixel supplied from the data compensator 350 to the display unit 500. The data driver 300 applies the compensated data voltage Vdat′ to the plurality of data lines D1 to Dm in response to the data control signal CONT2.

Each driving apparatus 100, 200, 300, 350, and 400 may be directly mounted on the display unit 500 in the form of at least one IC chip, may be mounted on a flexible printed circuit film or attached to the display unit 500 in the form of a tape carrier package (TCP), may be mounted on a separate printed circuit board, or may be integrated in the display unit 500 along with the signal lines S1 to Sn and D1 to Dm.

FIG. 2 is a circuit diagram showing a pixel example.

Referring to FIG. 2, each pixel PX of the organic light emitting display device includes an organic light emitting diode OLED and a pixel circuit 10 for controlling the organic light emitting diode OLED. The pixel circuit 10 includes a switching transistor M1, a driving transistor M2, and a sustain capacitor Cst.

The switching transistor M1 includes a gate electrode connected to a scan line Si, one end connected to a data line Dj, and the other end connected to a gate electrode of the driving transistor M2.

The driving transistor M2 includes the gate electrode connected to the other end of the switching transistor M1, one end connected to an ELVDD power source, and the other end connected to an anode of the organic light emitting diode OLED. The driving transistor M2 controls the amount of current flowing to the organic light emitting diode OLED from a first power source in response to a data voltage applied to the gate electrode.

The sustain capacitor Cst comprises one end connected to the gate electrode of the driving transistor M1 and the other end connected to the ELVDD power source. The sustain capacitor Cst is charged with the data voltage applied to the gate electrode of the driving transistor M2, and sustains the data voltage after the switching transistor M1 is turned off.

The organic light emitting diode OLED includes the anode connected to the other end of the driving transistor M2 and a cathode connected to an ELVSS power source. The organic light emitting diode OLED may emit light of one of primary colors. The primary colors include, i.e., three primary colors of red, green, and blue. A desired color is displayed with a spatial combination or temporal combination of the three primary colors.

The switching transistor M1 and the driving transistor M2 may be p-channel field effect transistors. In this case, the gate on voltage for turning on the switching transistor M1 and the driving transistor M2 is a voltage of logic low level, and the gate off voltage for turning off the switching transistor M1 and the driving transistor M2 is a voltage of logic high level.

Although the switching transistor M2 and the driving transistor M1 are illustrated as being p-channel field effect transistors, embodiments are not limited thereto. At least one of the switching transistor M2 and the driving transistor M2 may be an n-channel field effect transistor. In this case, the gate on voltage for turning on the n-channel field effect transistor is a voltage of logic high level, and the gate off voltage for turning off the n-channel field effect transistor is a voltage of logic low level.

Although a pixel structure using two transistors and one capacitor has been described, the organic light emitting display device according to embodiments may use pixels of various structures, as well as the pixel illustrated in FIG. 2.

Hereinafter, an operation of the organic light emitting display device will be described with reference to FIGS. 1 and 2.

The scan driver 200 applies the gate on voltage Von to a scan line Si in response to the scan control signal CONT1 to turn on the switching transistor M1. At this time, the data driver 300 applies a data voltage of logic low level to the data line Dj in response to the data control signal CONT2. The sustain capacitor Cst is charged with the data voltage, and the driving transistor M2 is turned on. A current corresponding to the data voltage is supplied to the anode of the organic light emitting diode OLED through the turned-on driving transistor M2. The organic light emitting diode OLED emits light corresponding to the amount of current flowing through the driving transistor M2.

The amount of current flowing through the driving transistor M2 is determined by the level of the data voltage applied to the gate electrode of the driving transistor M2 and the voltage level of the ELVDD power source. A voltage having the same level as the voltage of the ELVDD power source may be applied to pixels disposed close to the ELVDD power source, whereas a voltage having a lower level than the voltage of the ELVDD power source may be applied to pixels disposed far from the ELVDD power source due to a voltage drop across the power lines. Accordingly, the amount of current flowing through the driving transistor M2 may vary due to the voltage drop across the power lines. As a consequence, the light emitting amount of the organic light emitting diode OLED may vary, thereby deteriorating the picture quality of the organic light emitting display device.

In present embodiments, the ELVDD voltage applied to each pixel due to the voltage drop across the power lines is adapted to the image data signal DAT to thus generate a compensated data signal DAT′. The generated compensated data signal DAT′ is applied to the plurality of pixels to thus minimize the effect of the voltage drop across the power lines. The ELVDD voltage applied to each pixel refers to a voltage obtained by subtracting the voltage drop caused by the resistance of the power lines from the first power supply voltage ELVDD.

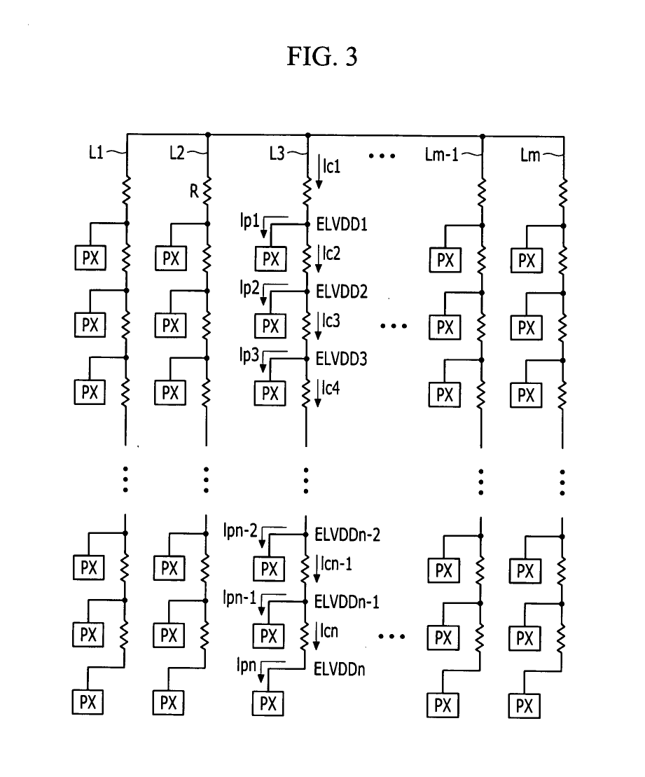

FIG. 3 is a block diagram showing an example of a wiring structure of power lines for describing the level of a power supply voltage actually applied to each pixel corresponding to a voltage drop across the power lines.

Referring to FIG. 3, a plurality of power lines L1 to Lm for supplying the first power supply voltage ELVDD to the plurality of pixels may extend from the first power source in a column direction along the columns of the plurality of pixels. Alternatively, the plurality of power lines L1 to Lm for supplying the first power supply voltage to the plurality of pixels may extend from the first power source in a row direction along the rows of the plurality of pixels. For convenience of explanation, it is assumed that the plurality of power lines L1 to Lm extend from the first power source in a column direction along the columns of the plurality of pixels.

Each of the pixels included in one pixel column is connected to its adjacent power line. A pixel disposed in the first position along a pixel row extending from the first power source is referred to as a first pixel, a pixel disposed in the second position along the pixel row is referred to as a second pixel, and a pixel disposed in the third position along the pixel row is referred to as a third pixel. In this manner, a pixel disposed in the nth position along the pixel row becomes an nth pixel.

A current flowing in the power line between the first power source and the junction of the first pixel is referred to as lc1, a current flowing in the power line between the junction of the first pixel and the junction of the second pixel is referred to as lc2, and a current flowing in the power line between the junction of the second pixel and the junction of the third pixel is referred to as lc3. In this manner, a current flowing in the power line between the junction of the (n-1)th pixel and the junction of the nth pixel.

In this case, the current flowing in the power lines may be given by Equation 1:

$$Ic 1 = Ic 2 + Ip 1 \\ Ic 2 = Ic 3 + Ip 2 \\ Ic 3 = Ic 4 + Ip 3 \\ ⋯ \\ Icn - 1 = Icn + Ipn - 1 \\ Icn = Ip n \qquad ( Equation 1 )$$

where Ip1 is the current flowing to the first pixel, lp2 is the current flowing to the second pixel, lp3 is the current flowing to the third pixel, lpn-1 is the current flowing to the (n-1)th pixel, and lpn is the current flowing to the nth pixel. Ip represents the pixel current flowing to the organic light emitting diode OLED of a pixel.

The current flowing in the power lines in Equation 1 can be given by Equation 2, when expressed as the current flowing through a pixel:

$$Ic 1 = Ip 1 + Ip 2 + Ip 3 + … + Ipn - 1 + Ipn \\ Ic 2 = Ip 2 + Ip 3 + … + Ipn - 1 + Ipn \\ Ic 3 = Ip 3 + … + Ipn - 1 + Ipn \\ ⋯ \\ Icn - 1 = Ipn - 1 + Ipn \\ Icn = Ipn \qquad ( Equation 2 )$$

The ELVDD voltage actually applied to each pixel is determined by the resistance of the power lines, which is proportional to the length of the power lines between the first power source and each pixel. The resistance of the power lines in the wiring structure of the power lines is indicated by resistance symbol R.

The ELVDD voltage applied to the first pixel is referred to as a first ELVDD voltage ELVDD1, the ELVDD voltage applied to the second pixel is referred to as a second ELVDD voltage ELVDD2, and the ELVDD voltage applied to the third pixel is referred to as a third ELVDD voltage ELVDD3. In this manner, the ELVDD voltage actually applied to the nth pixel becomes an nth ELVDD voltage ELVDDn. The first ELVDD voltage ELVDD1 is the voltage at the junction of the first pixel, the second ELVDD voltage ELVDD2 is the voltage at the junction of the second pixel, the third ELVDD voltage ELVDD3 is the voltage at the junction of the third pixel, and the nth ELVDD voltage ELVDDn is the voltage at the junction of the nth pixel.

The ELVDD voltage ELVDD1 to ELVDDn actually applied to each pixel due to a voltage drop IR-drop across the power lines is given by Equation 3:

$$ELVDD 1 = ELVDD - Ic 1 \times R \\ ELVDD 2 = ELVDD 1 - Ic 2 \times R \\ ELVDD 3 = ELVDD 2 - Ic 3 \times R \\ ⋯ \\ ELVDDn - 1 = ELVDDn - 2 - Icn - 1 \times R \\ ELVDDn = ELVDD - 1 - Icn \times R \qquad ( Equation 3 )$$

where ELVDD is the first power supply voltage. R represents the resistance of the power line between the first power source and the first pixel and the resistance of the power line between the junctions of each pixel. The resistance of the power lines may be determined by characteristics associated with the electrical conductivity of the material of the power lines and the thickness and length of the power lines. When it is assumed that the plurality of pixels included in the display unit 500 all have the same size and are uniformly arranged and the plurality of power lines have the same characteristics, the same resistance R of the power lines may apply to Equation 3.

By adapting Equation 2 to Equation 3, the ELVDD voltage ELVDD1 to ELVDDn can be given by Equation 4:

$$ELVDD 1 = ELVDD - ( Ip 1 + Ip 2 + Ip 3 + … + Ipn - 1 + Ipn ) \times R \\ ELVDD 2 = ELVDD - ( Ip 1 + 2 \times ( Ip 2 + Ip 3 + … + Ipn - 1 + Ipn ) ) \times R \\ ELVDD 3 = ELVDD - ( Ip 1 + 2 \times Ip 2 + 3 \times ( Ip 3 + … + Ipn - 1 + Ipn ) ) \times R \\ ⋯ \\ ELVDDn - 1 = ELVDD - ( Ip 1 + 2 \times Ip 2 + 3 \times Ip 3 + … + ( n - 1 ) \times ( Ipn - 1 + Ipn ) ) \times R \\ ELVDDn = ELVDD - ( Ip 1 + 2 \times Ip 2 + 3 \times Ip 3 ++ ( n - 1 ) \times Ipn - 1 + n \times Ipn ) ) \times R \qquad ( Equation 4 )$$

In this manner, given the first power supply voltage ELVDD, the pixel current lp flowing through each pixel, and the resistance R of the power lines, the ELVDD voltage ELVDD1 to ELVDDn can be obtained. The ELVDD voltage ELVDD1 to ELVDDn actually applied to each pixel is a voltage corresponding to a voltage drop across the power lines.

Now, a data driving apparatus for generating a compensated data signal DAT′, obtained by compensating for a voltage drop across the power lines, from the first power supply voltage ELVDD1 to ELVDDn corresponding to the voltage drop across the power lines and a driving method thereof will be described.

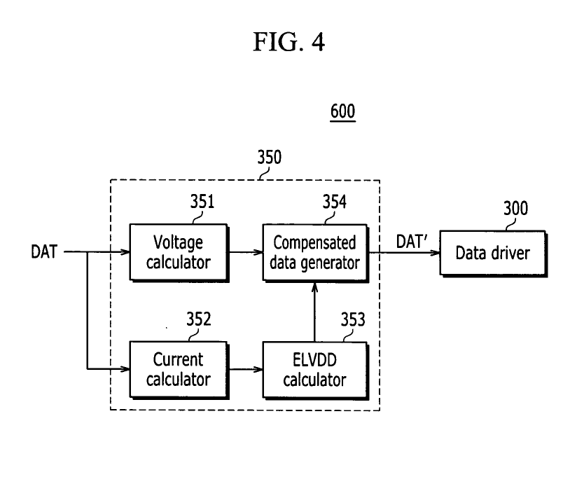

FIG. 4 is a block diagram showing a data driving apparatus according to an exemplary embodiment.

Referring to FIG. 4, the data driving apparatus 600 includes a data compensator 350 for generating a compensated data signal DAT′ obtained by compensating for a voltage drop across the power lines and a data driver 300 for supplying a compensated data voltage corresponding to the compensated data signal DAT′ to the display unit 500.

The data compensator 350 includes a voltage calculator 351, a current calculator 352, an ELVDD calculator 353, and a compensated data generator 354. An image data signal DAT including a bit value representing the gray level of each of the plurality of pixels is input into the voltage calculator 351 and the current calculator 352.

The voltage calculator 351 calculates the data voltage Vdat of each pixel from the image data signal DAT. The light emission efficiency of the organic light emitting diode OLED differs according to emission color. Thus, the voltage calculator 351 may calculate the data voltage Vdat from the image data signal DAT by taking into consideration the light emission efficiency of the organic light emitting diode OLED changing with emission color. In this case, the voltage calculator 351 may use the same resistance string DAC (R-string digital to analog converter) as a driving IC used in the data driver 300. The resistance string DAC of the voltage calculator 351 may use the same gamma voltage as the driving IC of the data driver 300. The voltage calculator 351 supplies the calculated data voltage Vdat to the compensated data generator 354.

The current calculator 352 calculates the pixel current flowing through the organic light emitting diode OLED of each pixel from the image data signal DAT. The pixel current flowing through the organic light emitting diode OLED of a pixel is given by Equation 5:

Ip=K×(ELVDD−Vdata_max×(Gray_DAT/Gray_max)^{Y})² (Equation 5)

where lp represents a pixel current, K represents a process constant determined by characteristics of the driving transistor for supplying the pixel current to the organic light emitting diode OLED, Vdata_max represents the data voltage for conducting the driving transistor to the maximum extent, Gray_DAT represents the gray level of each pixel included in the image data signal DAT, Gray_max represents the maximum number of representable gray levels, and γ represents a gamma value. Vdata_max is a data voltage of logic high level if the driving transistor is an n-channel field effect transistor, while Vdata_max is a data voltage of logic low level if the driving transistor is a p-channel field effect transistor. The gamma value may be 2.2. The current calculator 352 supplies the calculated pixel current of each pixel to the ELVDD calculator 353.

The ELVDD calculator 353 calculates the ELVDD voltage ELVDD1 to ELVDDn actually applied to each pixel by using the pixel current of each pixel. The ELVDD calculator 353 calculates the ELVDD voltage obtained by subtracting a voltage drop caused by the resistance of the power lines from the first power supply voltage ELVDD. The ELVDD calculator 353 is aware of the resistance R of the power lines, and can calculate the ELVDD voltage ELVDD1 to ELVDDn actually applied to each pixel by using Equation 4. The ELVDD calculator 353 supplies the ELVDD voltage ELVDD1 to ELVDDn actually applied to each pixel to the compensated data generator 354.

The compensated data generator 354 generates the compensated data signal DAT′ by using the data voltage Vdat corresponding to each pixel and the ELVDD voltage ELVDD1 to ELVDDn actually applied to each pixel. The compensated data signal DAT′ includes the compensated data voltage Vdat′ of each pixel. The compensated data generator 354 can obtain the compensated data voltage Vdat′ by using Equation 6. In this case, the driving transistor M2 is a p-channel field effect transistor.

Vdat′=Vdat−(ELVDD−ELVDD′) (Equation 6)

where Vdat′ represents the compensated data voltage applied to any one of the plurality of pixels, Vdat represents the data voltage of the corresponding pixel, ELVDD represents the first power supply voltage, and ELVDD′ represents the ELVDD voltage actually applied to the corresponding pixel. ELVDD-ELVDD′ represents the amount of voltage drop caused by the resistance of the power lines. The compensated data generator 354 may obtain the compensated data voltage Vdat′ by subtracting the voltage drop caused by the resistance of the power lines from the data voltage Vdat corresponding to the image data signal DAT.

The compensated data voltage Vdat′ falls by the amount of voltage drop caused by the resistance of the power lines from the data voltage Vdat. When the compensated data voltage Vdat′ is applied to the gate electrode of the driving transistor M2, which is a p-channel field effect transistor, the pixel current flowing through the driving transistor M2 increases by the amount of voltage drop caused by the resistance of the power lines. Accordingly, the organic light emitting diode OLED can emit light by the pixel current for compensating for the effect of the voltage drop across the power lines.

If the driving transistor M2 is an n-channel field effect transistor, the compensated data generator 354 can obtain the compensated data voltage Vdat′ by using Equation 7:

Vdat′=Vdat+(ELVDD−ELVDD′) (Equation 7)

The compensated data generator 354 may obtain the compensated data voltage Vdat′ by adding a voltage drop caused by the resistance of the power lines to the data voltage Vdat corresponding to the image data signal DAT.

The compensated data voltage Vdat′ rises by the amount of voltage drop caused by the resistance of the power lines from the data voltage Vdat. When the compensated data voltage Vdat′ is applied to the gate electrode of the driving transistor M2, which is an n-channel field effect transistor, the pixel current flowing through the driving transistor M2 increases by the amount of voltage drop caused by the resistance of the power lines. As a result, the organic light emitting diode OLED can emit light by the pixel current for compensating for the effect of the voltage drop across the power lines.

The compensated data generator 354 supplies the compensated data signal DAT′ comprising the compensated data voltage Vdat′ of each pixel to the data driver 300.

The data driver 300 applies the compensated data voltage Vdat′ to the display unit 500 in response to the data control signal CONT2.

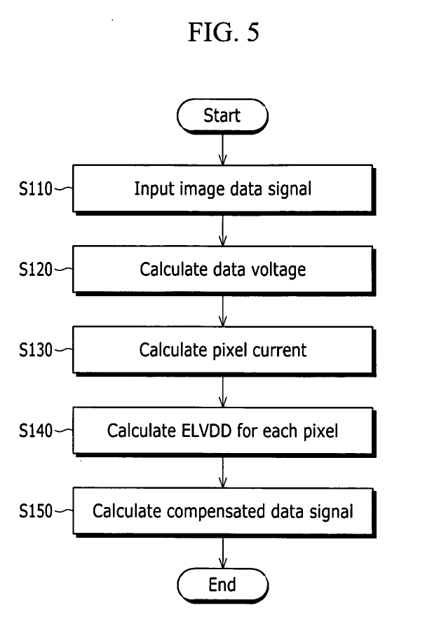

FIG. 5 is a flowchart showing a driving method of a data driving apparatus according to an exemplary embodiment.

Referring to FIG. 5, the image data signal DAT is input into the data driving apparatus 600 (S110). The image data signal DAT can represent the gray level of each of the plurality of pixels by a predetermined number of bits. For example, if the image data signal DAT is 10 bits, the image data signal DAT can represent 2¹⁰(=1024) gray levels. The image data signal DAT is input into the voltage calculator 351 and the current calculator 352.

The voltage calculator 351 of the data driving apparatus 600 calculates the data voltage Vdat of each pixel from the image data signal DAT (S 120). The voltage calculator 351 may calculate the data voltage Vdat of each pixel by taking into consideration the light emission efficiency of the organic light emitting diode OLED.

The current calculator 352 of the data driving apparatus 600 calculates the current of each pixel from the image data signal DAT (S130). The pixel current lp of each pixel can be calculated by the above Equation 5.

The ELVDD calculator 353 of the data driving apparatus 600 calculates the ELVDD voltage for each pixel by using the current lp of each pixel (S140). The ELVDD voltage for each pixel represents the ELVDD voltage ELVDD1 to ELVDDn actually applied to each pixel. Once the resistance R of the power lines is determined, the ELVDD voltage for each pixel can be calculated by using the above Equation 4 with reference to FIG. 3.

The compensated data generator 354 of the data driving apparatus 600 generates the compensated data signal DAT′ by using the data voltage Vdat corresponding to each pixel and the ELVDD voltage for each pixel (S150). The compensated data signal DAT′ includes the compensated data voltage Vdat′ of each pixel, and the compensated data voltage Vdat′ of each pixel can be calculated by using the above Equation 6 or 7 with reference to FIG. 4. The data driver 300 of the data driving apparatus 600 applies the compensated data voltage Vdat′ to the display unit 500 in response to the data control signal CONT2.

By way of summation and review, panels are becoming larger. Large panels have a problem of picture quality degradation caused by a voltage drop (IR-drop) across wires for supplying electrical power and data signals to pixels. A voltage, lower than the applied voltage, is supplied to the pixels due to the voltage drop across the wires. The lower voltage affects the amount of current flowing through the driving TFT, degrading the long range uniformity (LRU) of the display device.

Embodiments are directed to an organic light emitting display device, which can minimize the problem of picture quality degradation caused by the voltage drop across power lines, a data driving apparatus for an organic light emitting display device, and a driving method thereof. In particular, the problem of picture quality degradation caused by the voltage drop across the power lines can be minimized by generating a compensated data voltage Vdat′, compensating for a voltage drop in the ELVDD voltage, and applying the compensated data voltage Vdat′ to each pixel.

Exemplary embodiments have been disclosed herein, and although specific terms are employed, they are used and are to be interpreted in a generic and descriptive sense only and not for purpose of limitation.

What is claimed is:

1. An organic light emitting display device, comprising:
a display unit;
a power supply unit including a power source which generates a power supply voltage to drive the display unit;
a data compensator that adapts a voltage drop, caused by a resistance of power lines supplying the power supply voltage to a pixel included in the display unit, to a data voltage of the pixel and generates a compensated data voltage of the pixel; and
a data driver that applies the compensated data voltage to the display unit.

2. The organic light emitting display device as claimed in claim 1, wherein the pixel includes:
an organic light emitting diode; and
a driving transistor that controls an amount of current flowing to the organic light emitting diode from the power source in response to the compensated data voltage.

3. The organic light emitting display device as claimed in claim 2, wherein the driving transistor is a p-channel field effect transistor, and the compensated data voltage is generated by subtracting the voltage drop from the data voltage of the pixel.

4. The organic light emitting display device as claimed in claim 2, wherein the driving transistor is a n-channel field effect transistor, and the compensated data voltage is generated by adding the voltage drop to the data voltage of the pixel.

5. The organic light emitting display device as claimed in claim 1, wherein the data compensator includes:
a voltage calculator for calculating the data voltage of the pixel from an image data signal;
a current calculator for calculating a pixel current from the image data signal;
an ELVDD calculator for calculating an ELVDD voltage, obtained by subtracting the voltage drop from the power supply voltage, by using the pixel current; and
a compensated data generator for calculating the compensated data voltage by using the data voltage and the ELVDD voltage.

6. The organic light emitting display device as claimed in claim 5, wherein the voltage calculator calculates the data voltage from the image data signal based on a light emission efficiency of an organic light emitting diode included in the pixel.

7. The organic light emitting display device as claimed in claim 5, wherein the current calculator calculates the pixel current based on a ratio of gray levels of the pixel to a total number of gray levels.

8. The organic light emitting display device as claimed in claim 5, wherein the compensated data generator calculates the compensated data voltage by subtracting the voltage drop from the data voltage of the pixel.

9. The organic light emitting display device as claimed in claim 5, wherein the compensated data generator calculates the compensated data voltage by adding the voltage drop to the data voltage of the pixel.

10. A data driving apparatus for an organic light emitting display device, the data driving apparatus comprising:
a voltage calculator for calculating a data voltage of each of a plurality of pixels from an image data signal;
a current calculator for calculating a current of each of the plurality of pixels from the image data signal;
an ELVDD calculator for calculating an ELVDD voltage of each of the plurality of pixels, obtained by subtracting a voltage drop caused by a resistance of power lines from a power supply voltage of a power source, by using the current of each of the plurality of pixels;
a compensated data generator for calculating a compensated data voltage of each of the plurality of pixels by using the data voltage of each of the plurality of pixels and the ELVDD voltage of each of the plurality of pixels; and
a data driver for applying the compensated data voltage to a display unit including the plurality of pixels.

11. The data driving apparatus as claimed in claim 10, wherein the voltage calculator calculates the data voltage from the image data signal based on a light emission efficiency of a plurality of organic light emitting diodes included in the plurality of pixels.

12. The data driving apparatus as claimed in claim 10, wherein the current calculator calculates the current of each of the plurality of pixels according to
Ip=K×(ELVDD−Vdata_max×(Gray_DAT/Gray_max)^{Y})²,
where Ip represents the current of each of the plurality of pixels, K represents a process constant determined by a characteristic of a driving transistor for supplying the current of each of the plurality of pixels to the organic light emitting diode included in each of the plurality of pixels, Vdata_max represents a data voltage for conducting the driving transistor to a maximum extent, Gray_DAT represents a gray level of each of the plurality of pixels, Gray_max represents a maximum number of representable gray levels, and γ represents a gamma value.

13. The data driving apparatus as claimed in claim 10, wherein the compensated data generator calculates the compensated data voltage of each of the plurality of pixels according to Vdat′=Vdat−(ELVDD−ELVDD′),
where Vdat′ represents the compensated data voltage of each of the plurality of pixels, Vdat represents the data voltage of each of the plurality of pixels, ELVDD represents the power supply voltage of the power source, and ELVDD′ represents the ELVDD voltage of each of the plurality of pixels.

14. The data driving apparatus as claimed in claim 10, wherein the compensated data generator calculates the compensated data voltage of each of the plurality of pixels according to Vdat′=Vdat+(ELVDD−ELVDD′),
where Vdat′ represents the compensated data voltage of each of the plurality of pixels, Vdat represent the data voltage of each of the plurality of pixels, ELVDD represents the power supply voltage of the power source, and ELVDD′ represents the ELVDD voltage of each of the plurality of pixels.

15. A driving method of a data driving apparatus for an organic light emitting display device, the method comprising:
calculating a data voltage of a pixel from an image data signal;
calculating a pixel current from the image data signal;
calculating an ELVDD voltage of the pixel by using the pixel current; and
calculating a compensated data voltage of the pixel by using the data voltage and the ELVDD voltage.

16. The method as claimed in claim 15, wherein the ELVDD voltage of the pixel is obtained by subtracting a voltage drop caused by a resistance of power lines from a power supply voltage of a power source.

17. The method as claimed in claim 16, wherein the data voltage is calculated based on a light emission efficiency of an organic light emitting diode included in the pixel.

18. The method as claimed in claim 16, wherein the compensated data voltage is calculated by subtracting the voltage drop from the data voltage.

19. The method as claimed in claim 16, wherein the compensated data voltage is calculated by adding the voltage drop to the data voltage.
